(19) United States
(12) Patent Application Publication
(10) Pub. No.: US 2020/0016991 A1
(43) Pub. Date: Jan. 16, 2020

(54) CONVERSION DEVICE, ASSOCIATED CONTROL METHOD AND ASSOCIATED VEHICLE

(71) Applicant: IFP Energies Nouvelles, Rueil-Malmaison (FR)

(72) Inventors: El Hadj MILIANI, Rueil Malmaison (FR); Laid KEFSI, Villejuif (FR); Ismail ZEIN, Cergy (FR)

(73) Assignee: IFP Energies Nouvelles, Rueil-Malmaison (FR)

(21) Appl. No.: 16/335,035

(22) PCT Filed: Sep. 22, 2017
(86) PCT No.: PCT/FR2017/052553

§ 371 Date: Mar. 20, 2019

(30) Foreign Application Priority Data
Sep. 22, 2016 (FR) 16 58931

(51) Int. Cl. B60L 53/24; B60L 55/00; H02M 7/797

(52) U.S. Cl. CPC B60L 53/24; B60W 20/00; H02M 7/797; B60L 55/00

(57) ABSTRACT

The invention relates to a conversion device (4) allowing electrical energy to be transferred between a DC network (6) and an AC network (10), the conversion device (4) including: a DC-to-DC converter (12) comprising a first switch (20), a second switch (22), and a low-voltage branch (16) and a high-voltage branch (18), each comprising two sub-branches (34) in series, each sub-branch (34) comprising a switching module (38); an AC-to-DC converter (14); a controller (15) that is configured to control the closed or open state of the first switch (20), of the second switch (22) and of each switching module (38), the controller (15) being, additionally, configured to control the AC-to-DC converter (14) for transferring electrical energy from the DC-to-DC converter (12) to the AC network (10), or from the AC network (10) to the DC-to-DC converter (12).

### TECHNICAL FIELD

The present invention relates to a conversion device for an electric vehicle, enabling electric energy to be transferred between a DC power supply and an N-phase AC power supply, N being an integer higher than or equal to 1. The invention also relates to a method for controlling such a conversion device and a vehicle including such a device.

The invention is applicable to the field of electric converters, in particular electric converters for electric or hybrid vehicles.

### STATE OF PRIOR ART

An electric vehicle, respectively a hybrid vehicle, includes an electric energy source for providing energy necessary for actuating an electric traction motor to ensure vehicle propelling. The energy source is generally an onboard battery for supplying the traction motor through an inverter.

Yet, the battery can only store a limited amount of energy, and thus requires to be regularly recharged from another, more powerful, energy source, such as a home electric power supply. During the recharging operation, a charger sends the energy from the power supply to the battery to charge it.

The electric or hybrid vehicle is also likely to restore its stored energy to the electric power supply: this is called “V2G” (for “Vehicle to Grid”). In this case, a power electronic element is provided to send this energy to the electric power supply.

All these operations should be made in compliance with electromagnetic compatibility and security standards, and should be controlled by an efficient control system.

Generally, these operations are ensured by distinct power electronic devices, such as for example, an inverter, a charger, a DC-DC converter.

The multiplicity of such pieces of equipment results in a high bulk, heat stresses requiring a cooling system able to cool all of these pieces of equipment, as well as a high manufacturing cost.

Document WO 2010/057892 A1 describes a conversion device for an electric vehicle in which the inverter and charger functions of an electric vehicle are integrated in a same member.

However, such a conversion device is not fully satisfactory.

Indeed, such a device comprises two distinct branches for three phases, which makes its manufacture complex and expensive. Further, such a conversion device requires a specific electric motor necessitating a particular mechanical actuation to switch from one operating mode to another. Further, such a conversion device does not include any galvanic insulation element likely to prevent electric risks to people and the equipment.

One purpose of the invention is thus to provide a conversion device having a bulk and a manufacturing cost which are lower than the conversion devices of the state of the art, while having a simpler and more secure operation.

### DISCLOSURE OF THE INVENTION

To that end, one object of the invention is a conversion device of the aforementioned type, including:
a DC-DC converter comprising:
   a low voltage branch connected between a first low voltage terminal and a second low voltage terminal, and a high voltage branch connected between a first high voltage terminal and a second high voltage terminal, each of the low voltage branch and the high voltage branch comprising two sub-branches in series connected to each other at a middle point, each sub-branch comprising a switching module;
   a first switch connected between the first low voltage terminal and the first high voltage terminal, and a second switch connected between the second low voltage terminal and the second high voltage terminal;
   a transformer comprising a primary winding and a secondary winding magnetically coupled to each other, the primary winding being connected, through one of its ends, to the middle point of the low voltage branch, and through the other of its ends to a primary voltage reference, and the secondary winding being connected, through one of its ends, to the middle point of the high voltage branch, and through the other of its ends to a secondary voltage reference;
an AC-DC converter connected on the one hand to the first high voltage terminal and to the second high voltage terminal of the DC-DC converter, including N connection points each able to be connected to a corresponding phase of the AC power supply;
a controller configured to drive the ON or OFF state of the first switch, of the second switch and of each switching module, the controller being further configured to drive the AC-DC converter to transfer electric energy from the DC-DC converter to the AC power supply, or from the AC power supply to the DC-DC converter.

Indeed, thanks to such a conversion device, no mechanical actuation is required to switch from one operating mode to another. The operation of such a conversion device is thus simplified.

Further, in such a conversion device, a single circuit is able to make the various conversion operations, which results in a lesser bulk and a lower manufacturing cost than the conversion devices of the state of the art. Such an integration of functions further leads to the use of a single cooling circuit, which further reduces the bulk due to the conversion device.

Further, the presence of the transformer ensures a galvanic insulation between the direct current elements and the alternating current elements, which results in limiting electric risks to people and the equipment.

According to other advantageous aspects of the invention, the conversion device includes one or more of the following characteristics, taken alone or according to any technically possible combinations:
the controller is configured to, during a pulling phase or an energy restoration phase:
   control the first switch and the second switch such that they are in an OFF state;
   drive the switching modules of the DC-DC converter according to a control law of a boost converter configured to transfer electric energy from the low voltage branch to the high voltage branch;
   drive the AC-DC converter according to a control law of an inverter configured to transfer energy from the high voltage branch to the connection points of the AC-DC converter;
the controller is configured to, during a quick charging phase:
   control the first switch and the second switch such that they are in an OFF state;
   drive the AC-DC converter according to a control law of a rectifier configured to transfer energy from the connection points of the AC-DC converter to the high voltage branch;
   drive the switching modules of the DC-DC converter according to a control law of a buck converter configured to transfer electric energy from the high voltage branch to the low voltage branch;
the controller is configured to, during a slow charging phase during which two active connection points of the AC-DC converter are able to receive electric energy from the AC power supply:
   control the first switch and the second switch such that they are in an ON state;
   drive the AC-DC converter according to a control law of an H-bridge rectifier configured to transfer energy from the active
the DC-DC converter further comprises:
   an auxiliary branch extending between two connection terminals, and comprising two sub-branches in series connected to each other at a middle point, each sub-branch comprising a switching module able to switch between an OFF position preventing an electric current from flowing, and an ON position enabling an electric current to flow;
   an auxiliary winding magnetically coupled to the primary winding of the transformer, the primary winding being connected, through one of its ends, to the middle point of the auxiliary branch, and through the other of its ends, to an auxiliary voltage reference;
and the controller is configured to, during an accumulator charging phase:
   control the first switch and the second switch such that they are in an OFF state;
   drive the switching modules of the auxiliary branch according to a control law of a buck converter configured to transfer electric energy from the high voltage branch to the auxiliary branch.

Further, one object of the invention is a method for controlling a conversion device as defined above, the DC-DC converter being connected to a DC power supply through the first low voltage terminal and through the second low voltage terminal, the method including, during a pulling phase, the steps of:
connecting each connection point of the AC-DC converter to a corresponding phase of an electric motor;
controlling the first switch and the second switch such that they are in an OFF state;
driving the switching modules of the DC-DC converter according to a control law of a boost converter to transfer electric energy from the DC power supply to the high voltage branch;
driving the AC-DC converter according to a control law of an inverter to transfer energy from the high voltage branch to the electric motor.

According to other advantageous aspects of the invention, the method includes one or more of the following characteristics, taken alone or according to any technically possible combinations:
the method includes, during an energy restoration phase, the steps of:
   connecting each connection point of the AC-DC converter to a corresponding phase of an AC power supply;
   controlling the first switch and the second switch such that they are in an OFF state;
   driving the switching modules of the DC-DC converter according to a control law of a boost converter to transfer electric energy from the DC power supply to the high voltage branch;
   driving the AC-DC converter according to a control law of an inverter to transfer energy from the high voltage branch to the AC power supply;
the method includes, during a quick charging phase, the steps of:
   connecting each connection point of the AC-DC converter to a corresponding phase of an AC power supply;
   controlling the first switch and the second switch such that they are in an OFF state;
   driving the AC-DC converter according to a control law of a rectifier to transfer energy from the AC power supply to the high voltage branch;
   driving the switching modules of the DC-DC converter according to a control law of a buck converter to transfer electric energy from the high voltage branch to the DC power supply;
the method includes, during a slow charging phase, the steps of:
   connecting two active connection points of the AC-DC converter to corresponding phases of an AC power supply:
   controlling the first switch and the second switch such that they are in an ON state;
   driving the AC-DC converter according to a control law of an H-bridge to transfer energy from the AC power supply to the DC power supply;
the method includes, during an auxiliary charging phase, the steps of:
   controlling the first switch and the second switch such that they are in an OFF state;
   driving the switching modules of the DC-DC converter and the auxiliary branch according to a control law of a buck converter to transfer electric energy from the DC power supply to the auxiliary branch.

Further, another object of the invention is an electric or hybrid vehicle including a battery, an electric motor and a conversion device as defined above, the DC-DC converter being connected to the battery through the first low voltage terminal and through the second low voltage terminal, each connection point of the AC-DC converter being adapted to be connected to a corresponding phase of the electric motor.

### BRIEF DESCRIPTION OF THE DRAWINGS

The invention will be better understood upon reading the description that follows, given only by way of non-limiting example and made in reference to the appended drawings on which:

FIG. 1 is a schematic representation of an electrification line for an electric or hybrid vehicle according to the invention.

### DETAILED DISCLOSURE OF PARTICULAR EMBODIMENTS

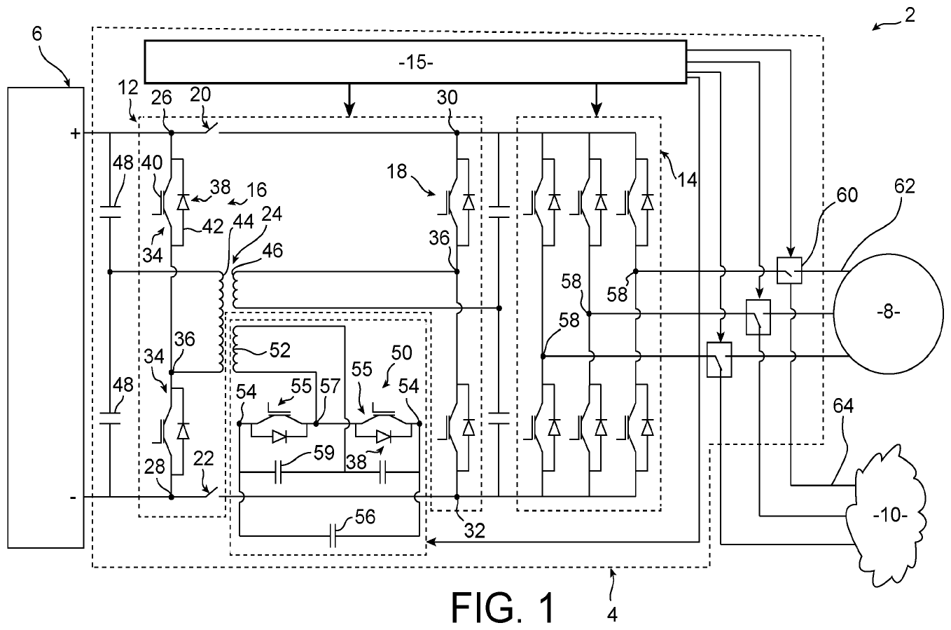

An electrification line 2 according to the invention is represented in FIG. 1. The electrification line 2 is in particular for being onboard an electric or hybrid vehicle, for example an electric or hybrid car.

The electrification line 2 comprises a conversion device 4, configured to transfer electric energy between a DC power supply and an N-phase AC power supply, N being an integer higher than or equal to 1.

The DC power supply consists of a battery 6.

The AC power supply consists of an electric motor 8 or an alternating current distribution system 10.

The conversion device 4 includes a DC-DC converter 12, an AC-DC converter 14 and a controller 15.

The DC-DC converter 12 is configured to convert a first DC voltage into a second different DC voltage.

The AC-DC converter 14 is configured to convert a DC voltage into an AC voltage, and to convert an AC voltage into a DC voltage.

The DC-DC converter 12 includes a low voltage branch 16, a high voltage branch 18, a first switch 20, a second switch 22 and a transformer 24.

The low voltage branch 16 is connected between a first low voltage terminal 26 and a second low voltage terminal 28. Further, the high voltage branch 18 is connected between a first high voltage terminal 30 and a second high voltage terminal 32.

As is apparent in FIG. 1, the DC-DC converter 12 is connected to the battery 6 through the first low voltage terminal 26 and the second low voltage terminal 28.

The low voltage branch 16 and the high voltage branch 18 each comprise two sub-branches 34 in series, connected to each other at a middle point 36.

Each sub-branch 34 includes a switching module 38 able to switch between an OFF state preventing an electric current from flowing, and an ON state enabling an electric current to flow.

For example, each switching module 38 comprises a transistor 40 and a diode 42 in parallel, the diode being reversely connected with respect to the transistor 40. For example, the transistor 40 is a MOSFET transistor or an IGBT transistor.

The first switch 20 is connected between the first low voltage terminal 26 and the first high voltage terminal 30. Further, the second switch 22 is connected between the second low voltage terminal 28 and the second high voltage terminal 32.

The first switch 20 and the second switch 22 are each able to switch between an OFF state preventing an electric current from flowing, and an ON state enabling an electric current to flow.

The transformer 24 comprises a primary winding 44 and a secondary winding 46 magnetically coupled to each other.

The primary winding 44 is connected, through one of its ends, to the middle point 36 of the low voltage branch 16, and through the other of its ends, to a primary voltage reference.

For example, and as illustrated by FIG. 1, the primary voltage reference consists of a middle point 36 between two capacitors 48 in series, connected in parallel to the low voltage branch 16, between the first low voltage terminal 26 and the second low voltage terminal 28.

The secondary winding 46 is connected, through one of its ends, to the middle point 36 of the high voltage branch 18, and, through the other of its ends, to a secondary voltage reference.

For example, and as illustrated in FIG. 1, the secondary voltage reference consists of a middle point 36 between two capacitors 48 in series, connected in parallel to the high voltage branch 18, between the first high voltage terminal 30 and the second low voltage terminal 32.

Advantageously, the DC-DC converter further comprises an auxiliary branch 50 and an auxiliary winding 52.

The auxiliary branch 50 extends between two connection terminals 54, and comprises two sub-branches 55 in series connected to each other at a middle point 57. Each sub-branch 55 of the auxiliary branch 50 is similar to the sub-branches 34 of the low voltage branch 16 or the high voltage branch 18.

The auxiliary winding 52 is magnetically coupled to the primary winding 44 of the transformer 24. Further, the auxiliary winding 52 is connected, through one of its ends, to the middle point 57 of the auxiliary branch 50, and, through the other of its ends, to an auxiliary voltage reference.

For example, and as illustrated by FIG. 1, the auxiliary voltage reference consists of a middle point between two capacitors 59 in series, connected in parallel to the auxiliary branch 50, between both connection terminals 54.

As illustrated in FIG. 1, an accumulator 56 is connected to the connection terminals 54 of the auxiliary branch 50.

The AC-DC converter 14 includes N connection points 58, each connection point being connected to a corresponding switch 60.

Each switch 60 is able to be controlled to connect a connection point 58 of the AC-DC converter 14 to a corresponding phase of the motor 8 or the distribution system 10.

Further, the AC-DC converter 14 is connected to the DC-DC converter at the first high voltage terminal 30 and the second high voltage terminal 32.

The AC-DC converter 14 has a known architecture allowing an operation as an inverter, a rectifier or an H-bridge.

The controller 15 is configured to drive the ON or OFF state of the first switch 20, the second switch 22 and of each switching module 38.

The controller 15 is further configured to drive the AC-DC converter to operate the AC-DC converter as an inverter, a rectifier or an H-bridge.

The operation of the electrification line 2 will now be described.

During a pulling phase, during which energy should be transferred from the battery 6 to the electric motor 8, the controller 15 controls the switches 60 to connect each connection point 58 of the AC-DC converter 14 to a corresponding phase 62 of the electric motor 8.

The controller 15 also controls the first switch 20 and the second switch 22 such that they are in an OFF state.

Further, the controller 15 drives the switching modules 38 of the DC-DC converter 12 according to a known control law of a boost converter to transfer electric energy from the battery 6 to the high voltage branch 18. The controller 15 also drives the AC-DC converter 14 according to a control law of an inverter known to transfer energy from the high voltage branch 18 to the electric motor 8.

During an energy restoration phase, also called “V2G”, during which electric energy should be transferred from the battery 6 to the distribution system 10, the controller 15 controls the switches 60 to connect each connection point 58 of the AC-DC converter 14 to a corresponding phase 64 of the distribution system 10.

The controller 15 also controls the first switch 20 and the second switch 22 such that they are in an OFF state.

Further, the controller 15 drives the switching modules 38 of the DC-DC converter 12 according to a known control law of a boost converter to transfer electric energy from the battery 6 to the high voltage branch 18. The controller 15 also drives the AC-DC converter 14 according to a control law of an inverter to transfer energy from the high voltage branch 18 to the distribution system 10.

During a quick charging phase, during which energy should be transferred from all the phases 64 of the distribution system 10 to the battery 6 to charge the battery 6, the controller 15 controls the switches 60 to connect each connection point 58 of the AC-DC converter 14 to a corresponding phase 64 of the distribution system 10.

The controller 15 also controls the first switch 20 and the second switch 22 such that they are in an OFF state.

Further, the controller 15 drives the AC-DC converter 12 according to a known control law of a rectifier to transfer energy from the distribution system 10 to the high voltage branch 18. The controller 15 also drives the switching modules 38 of the DC-DC converter 12 according to a known control law of a buck converter to transfer electric energy from the high voltage branch 18 to the battery 6.

During a slow charging phase, during which energy should be transferred from two phases 64 of the distribution system 10 to the battery 6 to charge the battery 6, the controller 15 controls the switches 60 to connect said two phases 64 to the corresponding connection point 58 of the AC-DC converter 14, called “active connection point”. The other connection points 58 of the AC-DC converter 14 are not connected.

The controller 15 also controls the first switch 20 and the second switch 22 such that they are in an ON state, such that the transformer 24 is bypassed, that is off-circuit.

Further, the controller 15 drives the AC-DC converter 12 according to a known control law of an H-bridge to transfer energy from the distribution system to the battery 6.

During an auxiliary charging phase, during which electric energy should be transferred from the battery 6 to the accumulator 56, the controller 15 controls the first switch 20 and the second switch 22 such that they are in an OFF state.

Further, the controller 15 drives the switching modules 38 of the DC-DC converter 12 and the auxiliary branch 50 according to a known control law of a buck converter to transfer electric energy from the battery 6 to the accumulator 56.

1. A conversion device for an electric vehicle, enabling electric energy to be transferred between a DC power supply and an N-phase AC power supply, N being an integer higher than or equal to 1,
the conversion device including:
a DC-DC converter comprising:
a low voltage branch connected between a first low voltage terminal and a second low voltage terminal, and a high voltage branch connected between a first high voltage terminal and a second high voltage terminal, each of the low voltage branch and the high voltage branch comprising two sub-branches in series connected to each other at a middle point, each sub-branch comprising a switching module;
a first switch connected between the first low voltage terminal and the first high voltage terminal, and a second switch connected between the second low voltage terminal and the second high voltage terminal;
a transformer comprising a primary winding and a secondary winding magnetically coupled to each other, the primary winding being connected, through one of its ends, to the middle point of the low voltage branch, and through another one of its ends to a primary voltage reference, and the secondary winding being connected, through one of its ends, to the middle point of the high voltage branch, and through another one of its ends to a secondary voltage reference;
an AC-DC converter connected on the one hand to the first high voltage terminal and to the second high voltage terminal of the DC-DC converter, including N connection points each able to be connected to a corresponding phase of the AC power supply;
a controller configured to drive the ON or OFF state of the first switch, of the second switch and of each switching module, the controller being further configured to drive the AC-DC converter to transfer electric energy from the DC-DC converter to the AC power supply, or from the AC power supply to the DC-DC converter.

2. The conversion device according to claim 1, wherein the controller is configured to, during a pulling phase or an energy restoration phase:
control the first switch and the second switch such that they are in an OFF state;
drive the switching modules of the DC-DC converter according to a control law of a boost converter configured to transfer electric energy from the low voltage branch to the high voltage branch;
drive the AC-DC converter according to a control law of an inverter configured to transfer energy from the high voltage branch to the connection points of the AC-DC converter.

3. The conversion device according to claim 1, wherein the controller is configured to, during a quick charging phase:
control the first switch and the second switch such that they are in an OFF state;
drive the AC-DC converter according to a control law of a rectifier configured to transfer energy from the connection points of the AC-DC converter to the high voltage branch;
drive the switching modules of the DC-DC converter according to a control law of a buck converter configured to transfer electric energy from the high voltage branch to the low voltage branch.

4. The conversion device according to claim 1, wherein the controller is configured to, during a slow charging phase during which two active connection points of the AC-DC converter are able to receive electric energy from the AC power supply:
control the first switch and the second switch such that they are in an ON state;
drive the AC-DC converter according to a control law of an H-bridge rectifier configured to transfer energy from the active connection points of the AC DC converter to the high voltage branch.

5. The conversion device according to claim 1, wherein the DC-DC converter further comprises:
an auxiliary branch extending between two connection terminals, and comprising two sub-branches in series connected to each other at a middle point, each sub-branch comprising a switching module able to switch between an OFF position preventing an electric current from flowing, and an ON position enabling an electric current to flow;
an auxiliary winding magnetically coupled to the primary winding of the transformer, the primary winding being connected, through one of its ends, to the middle point of the auxiliary branch, and through another one of its ends, to an auxiliary voltage reference;
and wherein the controller is configured to, during an accumulator charging phase:
control the first switch and the second switch such that they are in an OFF state;
drive the switching modules of the auxiliary branch according to a control law of a buck converter configured to transfer electric energy from the high voltage branch to the auxiliary branch.

6. A method for controlling a conversion device for an electric vehicle, enabling electric energy to be transferred between a DC power supply and an N-phase AC power supply, N being an integer higher than or equal to 1, the conversion device including:
a DC-DC converter comprising:
a low voltage branch connected between a first low voltage terminal and a second low voltage terminal, and a high voltage branch connected between a first high voltage terminal and a second high voltage terminal, each of the low voltage branch and the high voltage branch comprising two sub-branches in series connected to each other at a middle point, each sub-branch comprising a switching module;
a first switch connected between the first low voltage terminal and the first high voltage terminal, and a second switch connected between the second low voltage terminal and the second high voltage terminal;
a transformer comprising a primary winding and a secondary winding magnetically coupled to each other, the primary winding being connected, through one of its ends, to the middle point of the low voltage branch, and through another one of its ends to a primary voltage reference, and the secondary winding being connected, through one of its ends, to the middle point of the high voltage branch, and through another one of its ends to a secondary voltage reference;
an AC-DC converter connected on the one hand to the first high voltage terminal and to the second high voltage terminal of the DC-DC converter, including N connection points each able to be connected to a corresponding phase of the AC power supply;
a controller configured to drive the ON or OFF state of the first switch, of the second switch and of each switching module, the controller being further configured to drive the AC-DC converter to transfer electric energy from the DC-DC converter to the AC power supply, or from the AC power supply to the DC-DC converter,
the DC-DC converter being connected to a DC power supply through the first low voltage terminal and through the second low voltage terminal,
the method including, during a pulling phase, the steps of:
connecting each connection point of the AC-DC converter to a corresponding phase of an electric motor;
controlling the first switch and the second switch such that they are in an OFF state;
driving the switching modules of the DC-DC converter according to a control law of a boost converter to transfer electric energy from the DC power supply to the high voltage branch;
driving the AC-DC converter according to a control law of an inverter to transfer energy from the high voltage branch to the electric motor.

7. The method according to claim 6, including, during an energy restoration phase, the steps of:
connecting each connection point of the AC-DC converter to a corresponding phase of an AC power supply;
controlling the first switch and the second switch such that they are in an OFF state;
driving the switching modules of the DC-DC converter according to a control law of a boost converter to transfer electric energy from the DC power supply to the high voltage branch;
driving the AC-DC converter according to a control law of an inverter to transfer energy from the high voltage branch to the AC power supply.

8. The method according to claim 6, including, during a quick charging phase, the steps of:
connecting each connection point of the AC-DC converter to a corresponding phase of an AC power supply;
controlling the first switch and the second switch such that they are in an OFF state;
driving the AC-DC converter according to a control law of a rectifier to transfer energy from the AC power supply to the high voltage branch;
driving the switching modules of the DC-DC converter according to a control law of a buck converter to transfer electric energy from the high voltage branch to the DC power supply.

9. The method according to claim 6, including, during a slow charging phase, the steps of:
connecting two active connection points of the AC-DC converter to corresponding phases of an AC power supply:
controlling the first switch and the second switch such that they are in an ON state;
driving the AC-DC converter according to a control law of an H-bridge to transfer energy from the AC power supply to the DC power supply.

10. The method according to claim 6, wherein the DC-DC converter further comprises:
an auxiliary branch extending between two connection terminals, and comprising two sub-branches in series connected to each other at a middle point, each sub-branch comprising a switching module able to switch between an OFF position preventing an electric current from flowing, and an ON position enabling an electric current to flow;
an auxiliary winding magnetically coupled to the primary winding of the transformer, the primary winding being connected, through one of its ends, to the middle point of the auxiliary branch, and through another one of its ends, to an auxiliary voltage reference;
and wherein the controller is configured to, during an accumulator charging phase:
control the first switch and the second switch such that they are in an OFF state;
drive the switching modules of the auxiliary branch according to a control law of a buck converter configured to transfer electric energy from the high voltage branch to the auxiliary branch,
the method further including, during an auxiliary charging phase, the steps of:
controlling the first switch and the second switch such that they are in an OFF state;
driving the switching modules of the DC-DC converter and the auxiliary branch according to a control law of a buck converter to transfer electric energy from the DC power supply to the auxiliary branch.

11. An electric or hybrid vehicle including a battery, an electric motor and a conversion device according to claim 1, the DC-DC converter being connected to the battery through the first low voltage terminal and through the second low voltage terminal, each connection point of the AC-DC converter being adapted to be connected to a corresponding phase of the electric motor.
